(19) United States
(12) Patent Application Publication
(10) Pub. No.: US 2017/0074123 A1
(43) Pub. Date: Mar. 16, 2017

(54) ENHANCED CONDENSER FOR A WASTE HEAT RECOVERY SYSTEM

(71) Applicant: DANA LIMITED, MAUMEE, OH (US)

(72) Inventor: MARK R. J. VERSTEYHE, OOSTKAMP (BE)

(73) Assignee: DANA LIMITED, MAUMEE, OH (US)

(21) Appl. No.: 15/125,345

(22) PCT Filed: Mar. 20, 2015
(86) PCT No.: PCT/US15/21753

§ 371 Date: Sep. 12, 2016

Related U.S. Application Data
(60) Provisional application No. 61/968,469, filed on Mar. 21, 2014.

(51) Int. Cl. F01K 23/06; F01N 5/02; F01K 23/10; F02G 5/02

(52) U.S. Cl. CPC F01K 23/065; F02G 5/02; F01N 5/02; F01K 23/10

(57) ABSTRACT

A waste heat recovery system for use with a cooling system of an internal combustion engine is provided. The waste heat recovery system comprises a condenser, a pump, a fluid reservoir, a heat exchanger, an expansion device, and an auxiliary cooling device. The condenser is in thermal communication with the cooling system of the internal combustion engine. The heat exchanger is in fluid communication with the pump and thermal communication with an exhaust of the internal combustion engine. The expansion device is in fluid communication with the heat exchanger and the condenser. The auxiliary cooling device is in fluid communication with at least one of the condenser, the expansion device, and the fluid reservoir. In response to an effectiveness of the condenser in dissipating heat from the waste heat recovery system to the cooling system of the internal combustion engine, the auxiliary cooling device is selectively actuated.

### CLAIM OF PRIORITY

The present application claims the benefit of priority to U.S. Provisional Application No. 61/968,469 filed on Mar. 21, 2014, which is incorporated herein in its entirety by reference.

### FIELD OF THE INVENTION

The present invention relates to energy recovery systems and more specifically to heat dissipation for waste heat recovery systems used with internal combustion engines.

### BACKGROUND OF THE INVENTION

A conventional internal combustion engine typically has a limited brake thermal efficiency (BTE). Energy released during a combustion process utilized by the internal combustion engine is only partially converted to useful work. A large portion of the energy released during the combustion process is rejected as waste heat to an ambient environment of the internal combustion engine. The waste heat is typically dispersed to the ambient environment of the internal combustion engine through the use of a cooling system and an exhaust system of the internal combustion engine. Efficiencies of the internal combustion alone (not accounting for any power transmission losses) typically do not exceed about 50%.

An amount of energy that is rejected as waste heat to the ambient environment is proportional to a fuel consumption of the internal combustion engine. Further, an amount of energy that is rejected as waste heat is inversely proportional to an efficiency of the internal combustion engine. With increasing fuel costs and emission regulations becoming more and more stringent, new technologies to improve an efficiency of internal combustion engines are highly sought after.

FIG. 1 schematically illustrates a waste heat recovery (WHR) system 110 for use with an internal combustion engine 112 that is known in the art. The WHR system 110 is in driving engagement and fluid communication with the internal combustion engine 112. A portion of the WHR system 110 is in driving engagement with a portion of the internal combustion engine 112 through a mechanical connection 114. The WHR system 110 may utilize the organic Rankine cycle; however, it is understood that other thermodynamic cycles may also be used with the WHR system 110. It is understood that the components of the WHR system 110, the components of the internal combustion engine 112, and a working fluid used with the WHR system 110 may be adapted for use with other thermodynamic cycles. The internal combustion engine 112 includes a turbocharger 115. Typically, the internal combustion engine 112 is used as a power source for a vehicle (not shown); however, it is understood that the internal combustion engine 112 may be used in other applications, such as in stationary power generation applications.

The WHR system 110 comprises a pump 116, a heat exchanger 118, an expander 120, a condenser 122, and a plurality of fluid conduits 124. The pump 116 is in fluid communication with the heat exchanger 118 and the condenser 122. The expander 120 is in fluid communication with the condenser 122 and the heat exchanger 118. The WHR system 110 is a closed circuit, thermodynamic device that employs a liquid-vapor phase change to convert heat energy into motive power. It is understood that the WHR system 110 may include additional components not illustrated in FIG. 1, such as, but not limited to, a working fluid reservoir, a plurality of valves, and a plurality of sensors in communication with a control system. The plurality of fluid conduits 124 facilitate fluid communication to occur between each of the components 116, 118, 120, 122 and may comprise a plurality of preformed rigid tubes, flexible conduits, or conduits formed within a portion of each of the components 116, 118, 120, 122.

The heat exchanger 118 facilitates thermal communication between an exhaust conduit 126 of the internal combustion engine 112 and a portion of a plurality of fluid conduits 124 facilitating fluid communication between the components. It is understood that the heat exchanger 118 may comprise a plurality of heat exchangers. The heat exchanger 118 is conventional and well known in the art, and may also be referred to as an evaporator. As the working fluid passes through a portion of the heat exchanger 118, the working fluid is heated and evaporated by energy imparted to the working fluid by the exhaust gases passing through the exhaust conduit 126. As a result of the thermal communication between a portion of the plurality of fluid conduits 124 and the exhaust conduit 126, the working fluid leaves the heat exchanger 118 in a gaseous state.

In vehicular applications, the space available under hood for the additional components 116, 118, 120, 122 of the WHR system 110 is limited. Adding the heat exchanger 118 for the WHR system 110 in the front of the vehicle is often not an option or would require a complete redesign of the under hood layout.

It would be advantageous to develop a waste heat recovery system for an internal combustion engine that increases an efficiency of the internal combustion engine, is compatible with existing internal combustion engine components, and is minimally intrusive on conventional internal combustion engine layouts used with vehicles.

### SUMMARY OF THE INVENTION

Presently provided by the invention, a waste heat recovery system for an internal combustion engine that increases an efficiency of the internal combustion engine, is compatible with existing internal combustion engine components, and is minimally intrusive on conventional internal combustion engine layouts used with vehicles, has surprisingly been discovered.

In one embodiment, the present invention is directed to a waste heat recovery system for use with a cooling system of an internal combustion engine. The waste heat recovery system comprises a condenser, a pump, a fluid reservoir, a heat exchanger, an expansion device, and an auxiliary cooling device. The condenser is in thermal communication with the cooling system of the internal combustion engine. The fluid reservoir is in fluid communication with the pump. The heat exchanger is in fluid communication with the pump and thermal communication with an exhaust of the internal combustion engine. The expansion device is in fluid communication with the heat exchanger and the condenser. The auxiliary cooling device is in fluid communication with at least one of the condenser, the expansion device, and the fluid reservoir. In response to an effectiveness of the condenser in dissipating heat from the waste heat recovery system to the cooling system of the internal combustion engine, the auxiliary cooling device is selectively actuated.

In another embodiment, the present invention is directed to a combined internal combustion engine and waste heat recovery system. The combined internal combustion engine and waste heat recovery system comprises the internal combustion engine including a cooling system and the waste heat recovery system. The waste heat recovery system comprises a condenser, a pump, a fluid reservoir, a heat exchanger, an expansion device, and an auxiliary cooling device. The condenser is in thermal communication with the cooling system of the internal combustion engine. The fluid reservoir is in fluid communication with the pump. The heat exchanger is in fluid communication with the pump and thermal communication with an exhaust of the internal combustion engine. The expansion device is in fluid communication with the heat exchanger and the condenser. The auxiliary cooling device is in fluid communication with at least one of the condenser, the expansion device, and the fluid reservoir. In response to an effectiveness of the condenser in dissipating heat from the waste heat recovery system to the cooling system of the internal combustion engine, the auxiliary cooling device is selectively actuated.

In another embodiment, the present invention is directed to a combined internal combustion engine and waste heat recovery system. The combined internal combustion engine and waste heat recovery system comprises the internal combustion engine including a cooling system the waste heat recovery system. The waste heat recovery system comprises a condenser, a pump, a fluid reservoir, a heat exchanger, an expansion device, and an auxiliary cooling device. The condenser is in thermal communication with the cooling system of the internal combustion engine. The fluid reservoir is in fluid communication with the pump. The heat exchanger is in fluid communication with the pump and thermal communication with an exhaust of the internal combustion engine. The expansion device is in fluid communication with the heat exchanger and the condenser. The auxiliary cooling device is in fluid communication with the condenser and the fluid reservoir. The auxiliary device comprises one of a bypass valve and a splitter valve and a radiator. In response to an effectiveness of the condenser in dissipating heat from the waste heat recovery system to the cooling system of the internal combustion engine, the auxiliary cooling device is selectively actuated using one of the bypass valve and a splitter valve.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention will become readily apparent to those skilled in the art from the following detailed description when considered in the light of the accompanying drawings in which:

FIG. 1 is a schematic illustration of a combined internal combustion engine and waste heat recovery system according to the prior art;

FIG. 2 is a schematic illustration of a combined internal combustion engine and waste heat recovery system according to an embodiment of the present invention;

FIG. 3 is a schematic illustration of a combined internal combustion engine and waste heat recovery system according to another embodiment of the present invention;

FIG. 4 is a schematic illustration of a combined internal combustion engine and waste heat recovery system according to another embodiment of the present invention; and

FIG. 5 is an exemplary temperature versus entropy diagram for a refrigerant that may be used with the waste heat recovery system shown in FIGS. 2-4.

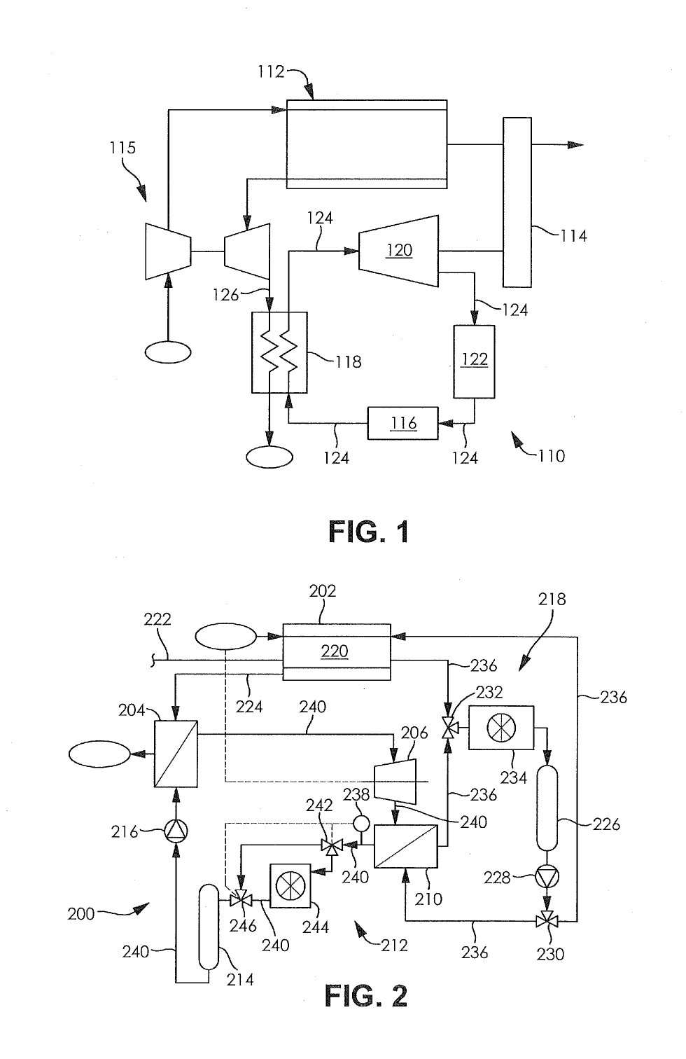

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise.

FIG. 2 illustrates an exemplary waste heat recovery (WHR) system 200 according to an embodiment of the invention, the WHR system 200 used with an internal combustion engine 202. The WHR system 200 captures waste heat to generate additional power for the internal combustion engine 202. The WHR system 200 includes a heat exchanger 204, an expansion device 206, a condenser 210, an auxiliary cooling device 212, a fluid reservoir 214, and a feed pump 216. A working fluid is pumped through the WHR system 200 to convert waste heat to power at the expansion device 206. The working fluid is a two-phase fluid or a mixture of such fluids fitting a temperature range of the waste heat flow from the internal combustion engine 202. The heat exchanger 204 captures the thermal energy in the waste heat from the internal combustion engine 202 to evaporate the working fluid. The vapors of the working fluid are then expanded in the expansion device 206 to generate additional useful work. The condenser 210 facilitates thermal communication between the working fluid leaving the expansion device 206 and a cooling system 218 of the internal combustion engine 202 to at least partially condense the working fluid. Before returning to the fluid reservoir 214, the working fluid may be directed through the auxiliary cooling device 212 for additional cooling.

The WHR system 200 may utilize the organic Rankine cycle; however, it is understood that other thermodynamic cycles may also be used with the WHR system 200. It is understood that the components of the WHR system 200 and a working fluid used may be adapted for use with other thermodynamic cycles. Typically, the internal combustion engine 202 is used as a power source for a vehicle (not shown); however, it is understood that the internal combustion engine 202 may be used in other applications, such as in stationary power generation applications.

The internal combustion engine 202 comprises a primary portion 220, an engine output 222, and the cooling system 218. The primary portion 220 is in thermal communication with the heat exchanger 204 through an exhaust 224 of the primary portion 220. The primary portion 220 and the expansion device 206 are in driving engagement with the engine output 222. The internal combustion engine 202 may be any type of internal combustion engine, and it is understood that the internal combustion engine 202 and the expansion device 206 may form a portion of driveline for a hybrid vehicle.

The primary portion 220 comprises at least an engine block; however, it is understood that the primary portion 220 may also include components typically used with an internal combustion engine, such as a plurality of valves, a plurality of pistons, at least one crankshaft, a plurality of connecting rods, a clutching device, a ratio adapting device, a fuel delivery system, an ignition system, and the cooling system. The engine output 222 is a mechanical component driven by the primary portion 220 and the expansion device 206. The engine output 222 may be a vehicle driveline or a portion of a vehicle driveline, such as a driveshaft, a transmission, or a flywheel.

The cooling system 218 is used to dissipate heat generated in the primary portion 220 during operation of the internal combustion engine 202. The cooling system 218 comprises a reservoir 226, a coolant pump 228, a splitter valve 230, a mixing valve 232, a radiator 234, and a plurality of coolant conduits 236. Typically, the cooling system 218 recirculates a liquid coolant using the coolant pump 228 from the reservoir 226 through the primary portion 220, the radiator 234, and back into the reservoir 226 to dissipate heat generated in the primary portion 220. The cooling system 218 may also be used to dissipate heat from the WHR system 200 by diverting a portion of the flow from the coolant pump 228 using the splitter valve 230. When diverting a portion of the flow from the coolant pump 228 using the splitter valve 230, coolant is pumped through the condenser 210, the mixing valve 232, the radiator 234, and back into the reservoir 226. The cooling system 218 is used to dissipate heat from the WHR system 200 in response to a signal generated by a sensor 238 or a control system (not shown) in communication with the splitter valve 230. The plurality of coolant conduits 236 facilitate fluid communication to occur between each of the components 226, 228, 230, 232, 234 and may comprise a plurality of preformed rigid tubes, flexible conduits, or conduits formed within a portion of each of the components 226, 228, 230, 232, 234. It is understood that a capacity of the cooling system 218 may be increased from cooling systems typically used with internal combustion engines to accommodate the dissipation of additional heat.

The WHR system 200 comprises the heat exchanger 204, the expansion device 206 in driving engagement with the engine output 222, the condenser 210, the auxiliary cooling device 212, the fluid reservoir 214, the feed pump 216, and a plurality of fluid conduits 240. The feed pump 216 is in fluid communication with the heat exchanger 204 and the fluid reservoir 214. The expansion device 206 is in fluid communication with the condenser 210 and the heat exchanger 204. The auxiliary cooling device 212 is in fluid communication with the condenser 210 and the fluid reservoir 214. The WHR system 200 is a closed circuit, thermodynamic device that employs a liquid-vapor phase change to convert heat energy into motive power. It is understood that the WHR system 200 may include additional components not illustrated in FIG. 2, such as, but not limited to, a plurality of valves, and a plurality of sensors in communication with a control system. The plurality of fluid conduits 240 facilitate fluid communication to occur between each of the components 204, 206, 210, 212, 214, 216 and may comprise a plurality of preformed rigid tubes, flexible conduits, or conduits formed within a portion of each of the components 204, 206, 210, 212, 214, 216.

The feed pump 216 transfers the working fluid used with the WHR system 200 from the fluid reservoir 214 to the heat exchanger 204 through a portion of the plurality of fluid conduits 240. The feed pump 216 is conventional and well known in the art. The feed pump 216 may be an electrically operated pump designed to transfer the working fluid in a liquid state. Alternately, it is understood that the feed pump 216 may be mechanically driven by a rotating component of the primary portion 220 or the expansion device 206.

The heat exchanger 204 facilitates thermal communication between the exhaust 224 and a portion of the plurality of fluid conduits 240. It is understood that the heat exchanger 204 may comprise a plurality of heat exchangers. The heat exchanger 204 is conventional and well known in the art, and may also be referred to as an evaporator. As the working fluid passes through a portion of the heat exchanger 204, the working fluid is heated and evaporated by energy imparted to the working fluid by the exhaust gases passing through the exhaust 224. As a result of the thermal communication between a portion of the plurality of fluid conduits 240 and the exhaust 224, the working fluid leaves the heat exchanger 204 in a gaseous state.

The expansion device 206 extracts work from the working fluid in the gaseous state. The expansion device 206 is conventional and well known in the art, and may also be referred to as a turbine. The expansion device 206 comprises a plurality of blades (not shown) attached to a rotor (not shown) which is rotatingly disposed in a housing (not shown). The expansion device 206 is drivingly engaged with the engine output 222 to deliver additional work to the internal combustion engine 202. A connection between the expansion device 206 and the engine output 22 might be used in many configurations. As non-limiting examples, the expansion device 206 can be connected to a crankshaft of the internal combustion engine 202, connected to a continuously variable transmission, connected to a gearbox, connected to a power take off, used to convert the energy to electricity, and/or the expansion device 206 can be connected to and used in combination with any after-treatment to reduce mono-nitrogen oxides from the exhaust of the internal combustion engine 202. One exemplary after-treatment to which the present invention is not limited is selective catalytic reduction.

During operation of the WHR system 200, the working fluid leaving the heat exchanger 204 is expanded in the expansion device 206, imparting work to the plurality of blades, and thus to the engine output 222. During expansion of the working fluid, the working fluid drives the expansion device 206 and the pressure and temperature of the working fluid are reduced. After exiting the expansion device 206, the working fluid continues within a portion of the plurality of fluid conduits 240 to the condenser 210.

The condenser 210 facilitates thermal communication between the working fluid in the gaseous state and the cooling system 218. The condenser 210 is a liquid to liquid heat exchanging device and is conventional and well known in the art. As the working fluid passes through a portion of the condenser 210, the working fluid is cooled as the energy within the working fluid is distributed by the condenser 210 to the liquid coolant used in the cooling system 218. The condenser 210 provides further cooling for the working fluid, in addition to the temperature drop that occurs as the working fluid passes through the expansion device 206. As a result of the thermal communication between the working fluid and the condenser 210, the working fluid at least partially condenses and leaves the condenser 210 at least partially in a liquid state. After passing through the condenser 210, the working fluid may be directed to the auxiliary cooling device 212 as described hereinbelow and then to the fluid reservoir 214 and then pumped to an increased pressure by the feed pump 212 so that the cycle may be repeated.

The auxiliary cooling device 212 is used to dissipate heat in the working fluid, in addition to heat dissipation provided by the condenser 210, during operation of the internal combustion engine 202. The auxiliary cooling device 212 comprises a bypass valve 242, a working fluid radiator 244, a mixing valve 246, and the sensor 238. Typically, the auxiliary cooling device 212 bypasses the working fluid radiator 244 through one of the fluid conduits 240. The auxiliary cooling device 212 may also be used to dissipate heat from the WHR system 200 by diverting a portion of the flow through the working fluid radiator 244 using the bypass valve 242. When diverting a portion of the flow through the working fluid radiator 244 using the bypass valve 242, working fluid flows through the bypass valve 242, the working fluid radiator 244, the mixing valve 246, and then to the fluid reservoir 214. The auxiliary cooling device 212 is used to dissipate additional heat from the WHR system 200 in response to a signal generated by the sensor 238 or a control system (not shown) in communication with the bypass valve 242. The auxiliary cooling device 212 is used to dissipate additional heat when a capacity of the condenser 210 to dissipate heat has been surpassed.

In use, during normal operating conditions of the internal combustion engine 202, the capacity of the radiator 234 for the liquid coolant will also be sufficient to cool the working fluid below the condensing temperature in the condenser 210.

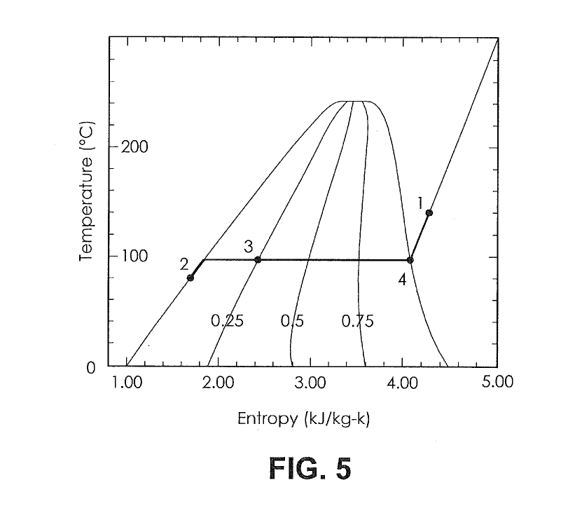

FIG. 5 illustrates an exemplary temperature versus entropy diagram for a refrigerant that may be used with the WHR system 200. A line and reference numerals on the diagram are representative of a state of the working fluid before and after the condenser 210. Reference numeral “1” is indicative of the working fluid in a superheated state. Reference numeral “2” is indicative of the working fluid in a sub-cooled state. The working fluid in a vaporized state enters the condenser 210 in the superheated state “1” and is cooled down until the sub-cooled state “2” is reached. FIG. 5 depicts vertically oriented lines at 0.25, 0.5 and 0.75 which represents where 25%, 50% and 75% of the working fluid is vapor with the balance being liquid. These lines are bounded by 0% lines and 100% lines, and between these lines vapor and liquid coexist. Thus, it can be appreciated that at 25%, ¼ of the liquid is vapor and ¾ is liquid in the state “3” described hereinabove. Preferably, a subcooled state “2” is reached a few degrees below the temperature in the condensing line, since the temperature is constant during the condensing step. This lower temperature is preferred to ensure the working fluid exiting the condenser 210 does not include vapor.

Due to the limited heat capacity of the radiator 234 and during high dynamic loads of the internal combustion engine 202, it is possible that the working fluid can no longer be cooled down to reach the subcooled state “2.” In this case, the temperature and/or pressure in the condenser 210 will increase and the overall performance of the WHR system 200 will decrease. Through the use of the auxiliary cooling device 212, the cooling capacity of the WHR system 200 can be increased once the radiator 234 has reached a maximum capacity. In this manner, the working fluid can be cooled down until the sub-cooled state “2” is reached again, and also the temperature and/or pressure in the condenser 210 can be controlled and maintained at a design level resulting in an optimal performance of the WHR system 200.

During normal operating conditions of the internal combustion engine 202, the working fluid radiator 244 is bypassed using the bypass valve 242 and the mixing valve 246. When a maximum heat capacity of the radiator 234 is exceeded, the working fluid can no longer be cooled down to the subcooled state “2.” The working fluid will then leave the condenser 210 at a higher temperature and/or pressure, for example state “3” shown in FIG. 5. The working fluid will leave the condenser 210 in state “3” partially as a vapor (25% vapor quality line) and at a higher temperature than the subcooled state “2.”

The temperature and/or pressure of the working fluid are measured at the outlet of the condenser 210 with the sensor 238. A control system (not shown) in communication with the sensor 238 and the bypass valve 242 and the mixing valve 246, controls a position of the bypass valve 242 and the mixing valve 246 based on a signal received from the sensor 238. When a temperature higher than the temperature of the sub-cooled state “2” is measure by the sensor 238, the bypass valve 242 and the mixing valve 246 are actuated and the working fluid radiator 244 is integrated into the WHR system 200. The total mass flow of the fluid is passed through the working fluid radiator 244 and the working fluid is cooled down from state “3” until the sub-cooled state “2” is reached again.

When the internal combustion engine 202 operates at the normal working point again, the working fluids will reach the sub-cooled state “2” at the outlet of the condenser 210 and the sensor 238 will actuate the bypass valve 242 and the mixing valve 246 to bypass the working fluid radiator 244.

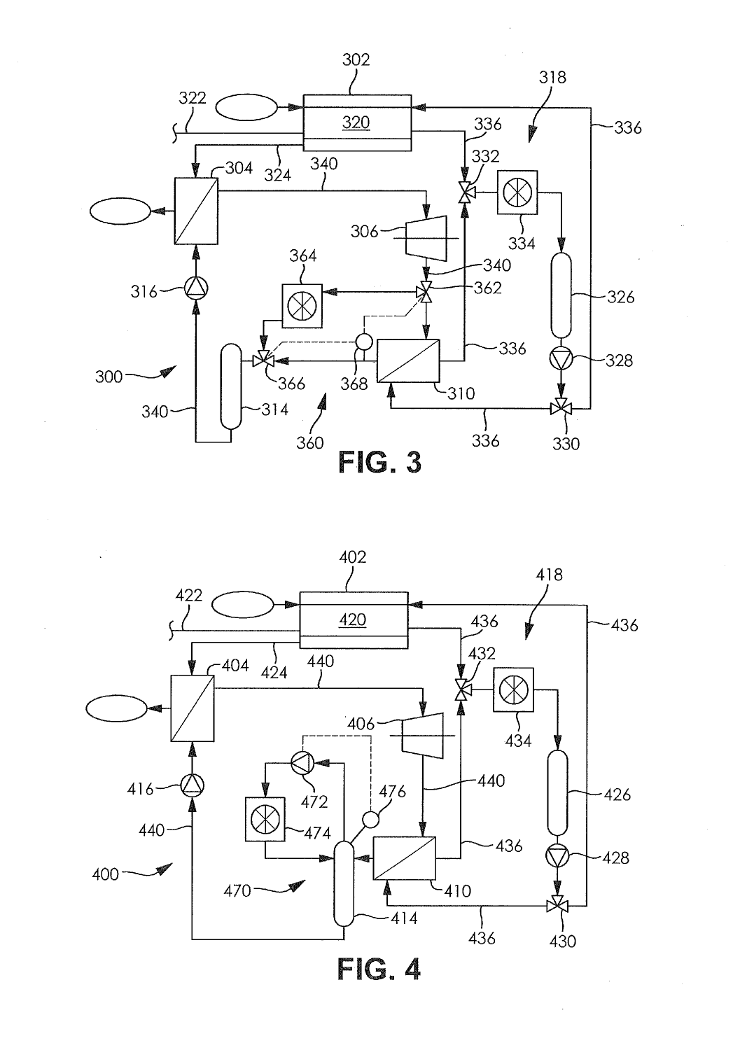

FIG. 3 illustrates a WHR system 300 used with an internal combustion engine 302 according to another embodiment of the invention. The embodiment shown in FIG. 3 includes similar components to the WHR system 200 used with an internal combustion engine 202 illustrated in FIG. 2. Similar features of the embodiment shown in FIG. 3 are numbered similarly in series, with the exception of the features described below.

The auxiliary cooling device 360 is used to dissipate heat in the working fluid, in addition to heat dissipation provided by the condenser 310, during operation of the internal combustion engine 302. The auxiliary cooling device 360 comprises a splitter valve 362, a working fluid radiator 364, a mixing valve 366, and the sensor 368. Typically, the auxiliary cooling device 360 bypasses the working fluid radiator 364 through the condenser 310 and two of the fluid conduits 340. The auxiliary cooling device 360 may also be used to dissipate heat from the WHR system 300 by diverting a portion of the flow through the working fluid radiator 364 using the splitter valve 362. When diverting a portion of the flow through the working fluid radiator 364 using the splitter valve 362, working fluid flows through the splitter valve 362, the working fluid radiator 364, the mixing valve 366, and then to the fluid reservoir 314. The auxiliary cooling device 360 is used to dissipate additional heat from the WHR system 300 in response to a signal generated by the sensor 368 or a control system (not shown) in communication with the splitter valve 362. The auxiliary cooling device 360 is used to dissipate additional heat when a capacity of the condenser 310 to dissipate heat has been surpassed.

The WHR system 300 comprises the heat exchanger 304, the expansion device 306 in driving engagement with the engine output 322, the condenser 310, the auxiliary cooling device 360, the fluid reservoir 314, the feed pump 316, and a plurality of fluid conduits 340. The feed pump 316 is in fluid communication with the heat exchanger 304 and the fluid reservoir 314. The expansion device 306 is in fluid communication with the splitter valve 362 of the auxiliary cooling device 360 and the heat exchanger 304. The auxiliary cooling device 360 is in fluid communication with the expansion device 306 and the fluid reservoir 314. The WHR system 300 is a closed circuit, thermodynamic device that employs a liquid-vapor phase change to convert heat energy into motive power. It is understood that the WHR system 300 may include additional components not illustrated in FIG. 3, such as, but not limited to, a plurality of valves, and a plurality of sensors in communication with a control system. The plurality of fluid conduits 340 facilitate fluid communication to occur between each of the components 304, 306, 310, 314, 316, 360 and may comprise a plurality of preformed rigid tubes, flexible conduits, or conduits formed within a portion of each of the components 304, 306, 310, 314, 316, 360.

At normal operating conditions of the internal combustion engine 202 the working fluid radiator 364 is bypassed by actuating the splitter valve 362 and the mixing valve 366. When the maximum heat capacity of the radiator 334 is exceeded, the working fluid can no longer be cooled down to the sub-cooled state “2” (see FIG. 5). The working fluid will leave the condenser 310 at a higher temperature and/or pressure. The temperature and/or pressure are measured at the outlet of the condenser 310 using the sensor 368. A control system (not shown) in communication with the sensor 368 and the splitter valve 362 and the mixing valve 366, controls a position of the splitter valve 362 and the mixing valve 366 based on a signal received from the sensor 368. When a temperature higher than the temperature of the sub-cooled state “2” is measured by the sensor 368, the splitter valve 362 and the mixing valve 366 are opened and the working fluid radiator 364 is integrated into the WHR system 300. The total mass flow of the working fluid is split by the splitter valve 362 and the mass flow is partially passed through the working fluid radiator 364. The sensor 368 controls and varies the opening of the splitter valve 362 between 0 and 100%. This way the mass flow and the outlet temperature of the condenser 310 are kept constant once the radiator 334 has reached its maximum capacity. When the cooling demand is higher than the maximum capacity of the radiator 334, the working fluid is partially passed through the working fluid radiator 364 where it is cooled down from superheated state “1” to the subcooled state “2” (see FIG. 5). So a total cooling demand of the working fluid is proportionally divided between the condenser 310 and the working fluid radiator 364 by splitting the mass flow. In both the condenser 310 and the working fluid radiator 364, the working fluid is cooled down from the superheated state “1” to the subcooled state “2.”

When the internal combustion engine 302 operates at its normal working point again, the fluids will reach the subcooled state “2” at the outlet of the condenser 310 and the sensor 368 will close the splitter valve 362 and the mixing valve 366, bypassing the working fluid radiator 364.

FIG. 4 illustrates a WHR system 400 used with an internal combustion engine 402 according to another embodiment of the invention. The embodiment shown in FIG. 4 includes similar components to the WHR system 200 used with an internal combustion engine 202 illustrated in FIG. 2. Similar features of the embodiment shown in FIG. 4 are numbered similarly in series, with the exception of the features described below.

The auxiliary cooling device 470 is used to dissipate heat in the working fluid, in addition to heat dissipation provided by the condenser 410, during operation of the internal combustion engine 402. The auxiliary cooling device 470 comprises an auxiliary compressor 472, a working fluid radiator 474, and a sensor 476. Typically, the auxiliary cooling device 470 is not used as the working fluid passes directly from the condenser 410 to the fluid reservoir 414. The auxiliary cooling device 470 is used to dissipate heat from the WHR system 400 by recirculating the working fluid in the fluid reservoir 414 through the working fluid radiator 474 using the auxiliary compressor 472. The auxiliary cooling device 470 is used to dissipate additional heat from the WHR system 400 in response to a signal generated by the sensor 476 or a control system (not shown) in communication with the auxiliary compressor 472. The auxiliary cooling device 470 is used to dissipate additional heat when a capacity of the condenser 410 to dissipate heat has been surpassed.

The WHR system 400 comprises the heat exchanger 404, the expansion device 406 in driving engagement with the engine output 422, the condenser 410, the auxiliary cooling device 470, the fluid reservoir 414, the feed pump 416, and a plurality of fluid conduits 440. The feed pump 416 is in fluid communication with the heat exchanger 404 and the fluid reservoir 414. The expansion device 406 is in fluid communication with the condenser 410 and the heat exchanger 304. The auxiliary cooling device 360 is in fluid communication with the fluid reservoir 414. The WHR system 400 is a closed circuit, thermodynamic device that employs a liquid-vapor phase change to convert heat energy into motive power. It is understood that the WHR system 400 may include additional components not illustrated in FIG. 4, such as, but not limited to, a plurality of valves, and a plurality of sensors in communication with a control system. The plurality of fluid conduits 440 facilitate fluid communication to occur between each of the components 404, 406, 410, 414, 416, 470 and may comprise a plurality of preformed rigid tubes, flexible conduits, or conduits formed within a portion of each of the components 404, 406, 410, 414, 416, 470.

At normal operating conditions of the internal combustion engine 402 the working fluid leaves the condenser 410 at the sub-cooled state “2” (see FIG. 5) and enters the fluid reservoir 414. When the maximum heat capacity of the radiator 434 is exceeded, the working fluid can no longer be cooled down to the sub-cooled state “2” and so the working fluid will leave the condenser 410 at a higher temperature and/or pressure, for example, state “3” shown in FIG. 5. The working fluid will leave the condenser 410 in state “3” partially as a vapor (25% vapor quality line, for example) and at a higher temperature than the sub-cooled state “2”. The temperature and/or pressure are measured in the fluid reservoir 414 using the sensor 476. A control system (not shown) in communication with the sensor 476 and the auxiliary compressor 472, controls the auxiliary compressor 472 based on a signal received from the sensor 476. When a temperature higher than the temperature of the sub-cooled state “2” is measure by the sensor 476, the auxiliary compressor 472 is activated and the working fluid radiator 474 is integrated into the WHR system 400. The vapor fraction is drawn out of the fluid reservoir 414 by the auxiliary compressor 472 and is passed through the working fluid radiator 474 where it is cooled down from state “4” to the sub-cooled state “2”, for example, before it re-enters the fluid reservoir 414.

When the internal combustion engine 402 operates at the normal working point again, the fluids will reach the sub-cooled state “2” at the outlet of the condenser 410 and the sensor 476 will shut down the auxiliary compressor 472.

A variation on the embodiment of the invention shown in FIG. 4 and described above comprises the use of a circulation pump to sub-cool the working fluid from the fluid reservoir 414 below the temperature at state “2”, instead of using the auxiliary compressor 472 to draw the vapor fraction out of the fluid reservoir 414 and cool the vapor down in the working fluid radiator 474. The working liquid is pumped by the circulation pump from the fluid reservoir 414 through the working fluid radiator 474 and the sub-cooled working fluid is sprayed at the top of the fluid reservoir 414 to facilitate condensing any vapor fraction that resides within the fluid reservoir 414 by absorbing heat from it.

In accordance with the provisions of the patent statutes, the present invention has been described in what is considered to represent its preferred embodiments. However, it should be noted that the invention can be practiced otherwise than as specifically illustrated and described without departing from its spirit or scope.

1-20. (canceled)

21. A waste heat recovery system for use with a cooling system of an internal combustion engine, comprising:
a condenser in thermal communication with the cooling system of the internal combustion engine;
a pump;
a fluid reservoir in fluid communication with the pump;
a heat exchanger in fluid communication with the pump and thermal communication with an exhaust of the internal combustion engine;
an expansion device in fluid communication with the heat exchanger and the condenser; and
an auxiliary cooling device in fluid communication with at least the fluid reservoir,
wherein in response to an effectiveness of the condenser in dissipating heat from the waste heat recovery system to the cooling system of the internal combustion engine, the auxiliary cooling device is selectively actuated.

22. The waste heat recovery system according to claim 21, wherein the auxiliary cooling device comprises a bypass valve and a radiator.

23. The waste heat recovery system according to claim 21, wherein the auxiliary cooling device comprises a splitter valve and a radiator.

24. The waste heat recovery system according to claim 21, wherein the auxiliary cooling device is in fluid communication with the condenser.

25. The waste heat recovery system according to claim 21, wherein the auxiliary cooling device is in fluid communication with the expansion device.

26. The waste heat recovery system according to claim 21, wherein the auxiliary cooling device further comprises a sensor, wherein information from the sensor is used to determine if the auxiliary cooling device is selectively actuated.

27. The waste heat recovery system according to claim 26, wherein the sensor is a pressure and temperature sensor.

28. A combined internal combustion engine and waste heat recovery system, comprising:
the internal combustion engine including a cooling system; and
the waste heat recovery system, comprising:
a condenser in thermal communication with the cooling system of the internal combustion engine;
a pump;
a fluid reservoir in fluid communication with the pump;
a heat exchanger in fluid communication with the pump and thermal communication with an exhaust of the internal combustion engine;
an expansion device in fluid communication with the heat exchanger and the condenser; and
an auxiliary cooling device in fluid communication with at least the fluid reservoir,
wherein in response to an effectiveness of the condenser in dissipating heat from the waste heat recovery system to the cooling system of the internal combustion engine, the auxiliary cooling device is selectively actuated.

29. The combined internal combustion engine and waste heat recovery system according to claim 28, wherein the auxiliary cooling device comprises a bypass valve and a radiator.

30. The combined internal combustion engine and waste heat recovery system according to claim 28, wherein the auxiliary cooling device comprises a splitter valve and a radiator.

31. The combined internal combustion engine and waste heat recovery system according to claim 28, wherein the auxiliary cooling device comprises a compressor and a radiator.

32. The combined internal combustion engine and waste heat recovery system according to claim 28, wherein the auxiliary cooling device is in fluid communication with the condenser.

33. The combined internal combustion engine and waste heat recovery system according to claim 28, wherein the auxiliary cooling device is in fluid communication with the expansion device.

34. The combined internal combustion engine and waste heat recovery system according to claim 28, wherein the auxiliary cooling device further comprises a sensor, wherein information from the sensor is used to determine if the auxiliary cooling device is selectively actuated.

35. The combined internal combustion engine and waste heat recovery system according to claim 34, wherein the sensor is a pressure and temperature sensor.

36. A waste heat recovery system for use with a cooling system of an internal combustion engine, comprising:
a condenser in thermal communication with the cooling system of the internal combustion engine;
a pump;
a fluid reservoir in fluid communication with the pump;
a heat exchanger in fluid communication with the pump and thermal communication with an exhaust of the internal combustion engine;
an expansion device in fluid communication with the heat exchanger and the condenser; and
an auxiliary cooling device comprising a compressor and a radiator and in fluid communication with at least one of the condenser, the expansion device, and the fluid reservoir,
wherein in response to an effectiveness of the condenser in dissipating heat from the waste heat recovery system to the cooling system of the internal combustion engine, the auxiliary cooling device is selectively actuated.

37. The waste heat recovery system according to claim 36, wherein the auxiliary cooling device is in fluid communication with the fluid reservoir.

38. The waste heat recovery system according to claim 37, wherein the auxiliary cooling device is in fluid communication with the condenser and the fluid reservoir.

39. The waste heat recovery system according to claim 37, wherein the auxiliary cooling device is in fluid communication with the expansion device and the fluid reservoir.

40. The waste heat recovery system according to claim 36, wherein the auxiliary cooling device further comprises a sensor, wherein information from the sensor is used to determine if the auxiliary cooling device is selectively actuated.

41. The waste heat recovery system according to claim 40, wherein the sensor is a pressure and temperature sensor.

42. A combined internal combustion engine and waste heat recovery system, comprising: the internal combustion engine including a cooling system and the waste heat recovery system of claim 36.
